(19) United States
(12) Patent Application Publication
(10) Pub. No.: US 2003/0009368 A1
(43) Pub. Date: Jan. 9, 2003

(54) Method of predicting a customer's business potential and a data processing system readable medium including code for the method

(76) Inventor: Brendan J. Kitts, Cambridge, MA (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 09/682,000

(22) Filed: Jul. 6, 2001

(51) Int. Cl. G06F 17/60

(52) U.S. Cl. 705/10

(57) ABSTRACT

A method can be used to predict the purchasing potential of customers. In one embodiment, the prediction can be based in part on transactional data that is routinely collected by many businesses. An item preference model, a maximum spending model, a geographic model, and any combination of them can be used to make the prediction. The item preference model can be based on which items the customer prefers based on transactional data. The maximum spending model can use the daily maximum spending amount for a customer to determine potential. The geographic model may be based on distance or geographic indicate. Using any or all of the models, if the customer is spending below his or her predicted potential, he or she may be targeted for offers or other promotions.

### BACKGROUND OF INVENTION

1. Field of the Invention

This invention relates in general to methods and data processing system readable storage media, and more particularly, to methods of predicting business potential of customers and data processing system readable media having software code for carrying out those methods.

2. Description of the Related Art

Customer spending potential is a theoretical measure of the amount of money a customer has to spend in a particular business segment, for instance, in hotel night stays or in weekly groceries, when the customer's spending is added over all establishments he or she uses for those particular items. If a retailer were able to know a customer's spending potential, it could ignore customers who are already spending at their ceiling and concentrate marketing on those customers who have untapped potential or “upside.”

Previous approaches to calculating potential may have been deficient in one or more ways, ranging from cost and accuracy, to protection of consumer data.

One way to assess potential would be to gather transactional data from all the companies a customer frequents, and thereby, achieve a complete picture of the customer's spending behavior. However, many companies are not willing to share information about their customers since that data is seen as one of their competitive advantages. Of even greater concern are the privacy issues relating to this kind of “customer dossier” building.

Despite such concerns, some companies have developed business models based on data sharing. “Brokered on-line affiliate programs” are one such example. Under this scheme, major web retailers, such as Amazon.com, Inc. allow sites (called affiliates) to show advertisements for their products. After a user clicks on one of the advertisements, the clickthrough is sent to a broker company, which records the clickthrough. In turn, the broker bills Amazon.com for that clickthrough and makes payment to the affiliate. Since these affiliate brokers can mediate hundreds of retailers, they can build a database that tracks consumer purchases across several sites. This consumer spending information can then be sold to retailers.

However, this practice raises significant privacy issues, and many companies may want to avoid using it for this reason. Current legislative efforts in the United States and the European Union may further restrict or effectively prohibit some of the clickthrough activities.

An alternative is to use surveys to ascertain a customer's potential. To determine potential, the customers are simply asked their total spending per week. However, surveys are expensive to run (e.g., telephone surveys can cost US$30,000 for just 1,000 respondents). If a franchise has millions of customers, the cost of surveying everyone that is a customer or a potential customer can be prohibitive. Another approach is to run surveys on a small sample of the population (say 1%), and then use regression (or other methods) to impute the missing potentials to the remainder of the population (those not surveyed).

Two companies which specialize in surveying customer market share are Information Resources, Inc. (IRI) and ACNielsen. Both companies conduct surveys on customer purchase behaviour across multiple businesses using experimental groups with thousands of customers. ACNielsen maintains a test market of some 52,000 households, whilst IRI maintains 60,000 households. ACNielsen distributes in-home bar-scanners to its participating households and has consumers scan their shopping items after they get home with groceries.

IRI, on the other hand, has customers use special cards when they shop. The cards are accepted at multiple retailers. Customers participating in the program sign a contract allowing their purchases to be assembled and tracked, in exchange for a free cable TV converter and the chance at monthly sweepstakes. IRI also maintains 25,000 households which use in-home scanners similar to ACNielsen. The retailers allow their data to be shared (only a small percentage of the population), and they have no other way to gather information on what percentage of their various markets each retailer is capturing. (C. Thissen and J. Karolefski, 1998, “Target 2000: The rise of techno-marketing”, Retail Systems Consulting).

Using this information, both IRI and ACNeilsen can monitor customer spending per week across multiple vendors, and hence what percent of wallet each vendor is capturing. They then extrapolate these figures to all markets in the US.

However, there are several problems with using surveys.

Most retailers cannot afford to run surveys on this scale, or do it frequently enough to receive timely information.

Even IRI and ACNeilsen, with their tremendous outlay of expense, cover only a tiny percentage of houses in a retailer's market.

Extrapolating from small samples can be unreliable.

Survey methods usually rely on self-report, which can be systematically biased.

Surveys have problems with self-selection. The group of customers that responds to surveys may not be a random section of the population. For example, customers who requested not to be solicited had higher income and spending levels than the rest of the population. Thus, businesses relying upon surveys may find themselves responding to an atypical subgroup of the population.

Customers who do not want to participate in surveys will never be captured by such an effort. Their data is lost.

Further barriers to assessing customer wallet information include the fact that most retailers cannot ask their customers to scan-in any products they buy elsewhere. Furthermore, companies may not share their data and may be prevented from doing so by privacy restrictions.

Thus, a need exists for a way for retailers to assess a customer's potential or total wallet spending, (a) using the retailer's own data, (b) without running expensive surveys or extrapolating from small survey samples, (c) where all customers can be scored, not just some, and (d) where the solution will operate on the vast amounts of data which retailers collect in the course of daily business.

### SUMMARY OF INVENTION

Methods have been created to reasonably predict the business potential of customers. In some embodiments, the prediction may be made using transactional data without the need for surveying customers or obtaining information from third parties, each of which can be costly or time consuming. Because the information can be collected by a vendor in relation to its own business activities, and not disclosed to or shared with other vendors, privacy concerns can, to a large degree, be reduced. The method can be executed in linear or N*log(N) time, where N is the number of transactions (row) in the database, and use substantially constant size of random access memory (RAM) space.

In one set of embodiments, a method of predicting a business potential for a first customer comprises accessing data regarding the first customer of a vendor and assigning a value for the business potential for the first customer. The value can be a function of at least a behavior for a group of individuals in a population and can be based at least in part on the data regarding the first customer. In some specific embodiments of the method, the business potential can be based in part on the behavior of other similar customers in the population.

In other specific embodiments of the method, the business potential for a customer can be based in part on the geographic location, item purchasing (or browsing) behavior, or maximum spending records for a customer. “Nearest neighbor,” regression, or other techniques can be used in determining the business potential for a customer.

In one specific embodiment, the method can comprise determining an individualized result and one or more group results, comparing the results, and determining which group(s) the customer more closely matches, and hence which potential spending the customer is predicted to have. In an “item preference” embodiment, the individualized result can include an individual preference score based on items purchased by the customer, and the group-wide result can include group-wide preference scores based on items purchased by other customers within a group of customers.

In a “maximum spending” embodiment, the individualized result can include a maximum amount spent by the customer during a single transaction or over a time period, and the group-wide result can include a function of maximum amounts spent by customers within a group of customers during a single transaction or over the same or different time period.

In other specific embodiments of the method, a “geographic model” can be used. The method can further comprise using the data of the customer to determine an approximate distance between the customer and a location of the vendor. The distance can then be used for determining the potential. In another embodiment, the method can further comprise using the data to determine a geographic indicator (e.g., address, postal code, telephone number, or the like). The geographic indicator can be used for determining the potential.

The method can use any or all of the item preference, maximum spending, and geographic embodiments. Values from each of these embodiments can be used for a global model.

In other embodiments, a data processing system readable medium can have code embodied within it. The code can include instructions executable by a data processing system. The instructions may be configured to cause the data processing system to perform the methods described herein.

The foregoing general description and the following detailed description are exemplary and explanatory only and are not restrictive of the invention, as defined in the appended claims.

### BRIEF DESCRIPTION OF DRAWINGS

The present invention is illustrated by way of example and not limitation in the accompanying figures, in which like references indicate the same elements, and in which:

FIG. 1 includes an illustration of a functional block diagram of a system that can be used in performing data processing system-implemented methods;

FIG. 2 includes an illustration of a data processing system storage medium including software code having instructions in accordance with an embodiment of the present invention; and

FIG. 3 includes a process flow diagram for determining a purchasing potential for a customer.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

A method or data processing system readable medium can be used to predict the business potential of customers. In one embodiment, the prediction can be based in part on transactional data that is routinely collected by many businesses. The potential can be related to customer preferences for products or services, maximum amounts spent by customers during a single transaction or a predetermined length of time, geographic locations, any combination of these, or the like. The method can be used to identify customers that are currently spending under their predicted potential, so that marketing or other efforts may be targeted to those customers to increase their spending at one or more sites of a vendor. The method can be performed in linear time or N*log(N) time and use constant space in random access memory (RAM).

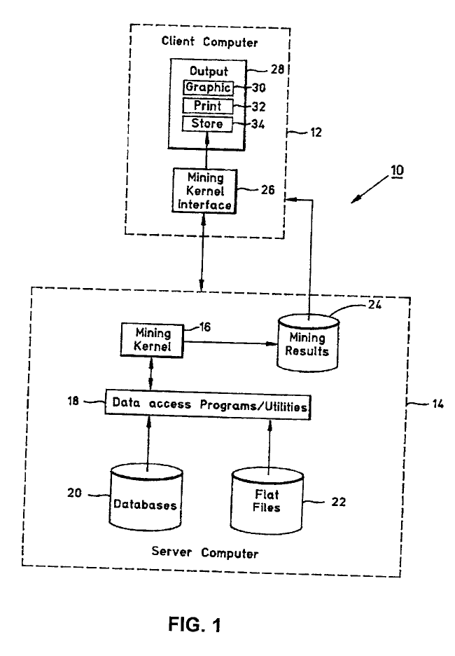

FIG. 1 includes a system 10 for mining databases. In the particular architecture shown, the system 10 can include one or more data processing systems, such as a client computer 12 and a server computer 14. The server computer 14 may be a Unix computer, an OS/2 server, a Windows NT server, or the like. The server computer 14 may control a database system, such as DB2 or ORACLE, or it may have data on files on some data processing system readable storage medium, such as disk or tape.

As shown, the server computer 14 includes a mining kernel 16 that may be executed by a processor (not shown) within the server computer 14 as a series of computer-executable instructions. These instructions may reside, for example, in the random access memory (RAM) of the server computer 14. The RAM is an example of a data processing system readable medium that may have code embodied within it. The code can include instructions executable by a data processing system (e.g., client computer 12 or server computer 14), wherein the instructions are configured to cause the data processing system to perform a method of predicting a potential purchasing amount for a customer. The method is described in more detail later in this specification.

FIG. 1 shows that, through appropriate data access programs and utilities 18, the mining kernel 16 can access one or more databases 20 or flat files (e.g., text files) 22 that contain data chronicling transactions. After executing the instructions for methods, which are more fully described below, the mining kernel 16 can output relevant data it discovers to a mining results repository 24, which can be accessed by the client computer 12.

Additionally, FIG. 1 shows that the client computer 12 can include a mining kernel interface 26 which, like the mining kernel 16, may be implemented in suitable software code. Among other things, the interface 26 may function as an input mechanism for establishing certain variables, such as the number of groups, the profile normalization method to be used, and the like. Further, the client computer 12 may include an output module 28 for outputting/displaying the mining results on a graphic display 30, a print mechanism 32, or a data processing system readable storage medium 34.

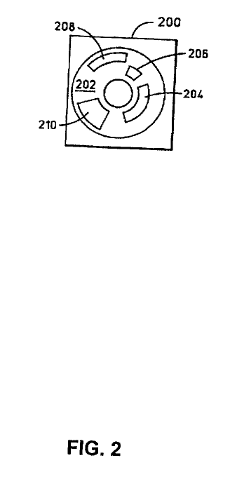

In addition to RAM, the instructions in an embodiment of the present invention may be contained on a data storage device with a different data processing system readable storage medium, such as a floppy diskette. FIG. 2 illustrates a combination software code elements 204, 206, 208 and 210 that are embodied within a data processing system readable medium 202 on a floppy diskette 200. Alternatively, the instructions may be stored as software code elements on a DASD array, magnetic tape, conventional hard disk drive, electronic read-only memory, optical storage device, CD ROM or other appropriate data processing system readable medium or storage device.

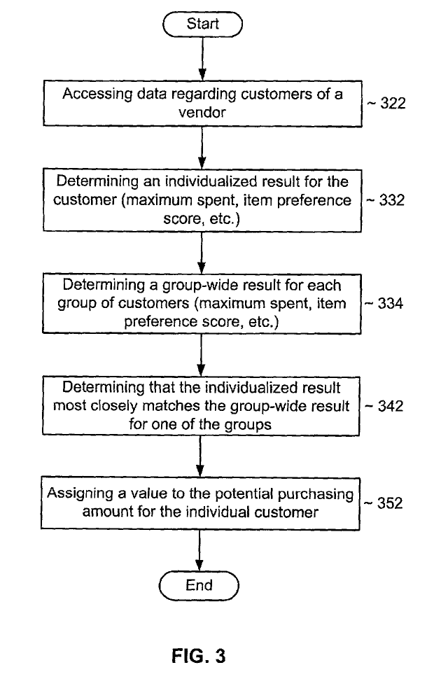

In an illustrative embodiment of the invention, the computer-executable instructions may be lines of compiled C⁺⁺, Java, or other language code. Other architectures may be used. For example, the functions of the client computer 12 may be incorporated into the server computer 14, and vice versa. FIG. 3 includes an illustration, in the form of a flow chart, of the operation of such a software program.

Communications between the client computer 12 and the server computer 14 can be accomplished using electronic or optical signals. When a user (human) is at the client computer 12, the client computer 12 may convert the signals to a human understandable form when sending a communication to the user and may convert input from a human to appropriate electronic or optical signals to be used by the client computer 12 or the server computer 14.

A customer's business potential is defined as the amount of money, web-clicks, or other transactional quantity of commercial interest that customer has to transact in a particular business segment (for instance, in hotel night stays, weekly groceries, or web-clicks), when the customer's transactions are added over all vendors he or she uses during a given time-period.

In many instances, the business potential can be a potential purchasing amount for a customer. However, many other business potentials may be of interest. For instance, a financial services company may want to find each customer's investment potential. An advertising company may want to find a customer's “ad-clickthrough-potential”, which is the number of clicks the company can expect to raise from that customer, upon exposing them to certain ad banners.

As used herein, an item can be a product or a service. The purchasing amount may be for an item, a category of item(s), a group of categories, or a type of retailer (grocery store, hardware store, department store, or the like). The purchasing amount can be a monetary measure (revenue or profit) or a volume measure (number of items purchases, number of views requested by a client at client computer 12, number of mouseclicks by the client, or the like).

The potential purchasing amount does not necessarily represent what the customer is currently spending at the store where the data is collected. The difference between the potential and actual numbers may reflect what the customer is spending at other grocers, for example.

Some of the methods described herein may be broken down into acts of: (i) collecting the data, (ii) generating profiles using a grouping algorithm, (iii) transforming, normalizing, and re-ordering the profiles, (iv) building a model, and (v) attributing scores to each customer in the population based on the potential model(s). A global model may include an item preference model, a maximum spending model, and a geographic model. The methods may be implemented in software within the mining kernel interface 26 or the mining kernel 16.

FIG. 3 includes a flow diagram for a method of determining a purchasing potential for a customer. The method can comprise accessing data regarding customers of a vendor (block 322). The method can also comprise determining an individualized result for the customer (maximum spent, item preference score, etc.) (block 332) and determining a group-wide result for each group of customers (maximum spent, item preference score, etc.) (block 334). The method can still further comprise determining that the individualized result most closely matches the group-wide result for one of the groups (block 342). The method can still further comprise assigning a value to the potential purchasing amount for the individual customer (block 352). Details of the method are given in the subsequent paragraphs that follow.

1. Collect the data.

The method can comprise collecting transactional data regarding customers of a vendor. This data may be in the form of revenue, profit, quantity, number of views, number of mouse-clicks, address, telephone number, or the like.

The vendor may have internet or electronic sites, a store (physical site), chain of stores (physical sites), or other physical location (e.g., a kiosk, a booth, or the like). The vendor may have at least 1,000 different items and in some instances over different items. The amount of sales data can exceed one million data points. However, note that more or fewer items may be used and more or fewer data points may be collected.

If possible, a whole year's worth of data should be collected. However, due to costs, time, or other constraints, this may not be possible. If a whole year's worth of data is not collected, the user should be aware of potential seasonal changes in some products. For example, within a grocery store, sales of cocoa and hot chocolate may be higher in the winter. If the data is only collected during winter, the model could overestimate sales of cocoa or hot chocolate during summer.

Behavioral data may be used for the item preference or maximum spending models described below. The geographic models described later may use other transactional data and may only need the address, telephone number, or other geographic indicator. Customer data regarding address, telephone number, or other geographic indicator may be sufficient. The data regarding customers of the vendor can be collected and stored by the vendor within database 20 of the server computer 14.

2. Generate customer profiles using a grouping algorithm.

The next stage is to generate customer and group profiles. A profile can be in a form of a vector with all the items that the customer has purchased or clicked on, and summarized in some manner.

A technique can be used for efficiently building the profiles. The method can comprise accessing the data regarding the customers of the vendor (block 322) and performing a contiguous re-ordering of the transaction data. A “grouping algorithm” can used to order the behavioral data and by customer. The ordered data has the same data but the records for any particular customer may be found on contiguous rows. Contiguous record re-ordering may be accomplished by a strategy of hashing to disk locations in linear time. An operation being performed linearly or in linear time means that the time for performing the operation is directly proportional to the number of records within the database. In other words, the computation time is substantially directly proportional to N, where N is the number of transactions being analyzed.

In situations where a disk-based grouping algorithm is unavailable, the data can be sorted by customer to accomplish the same contiguous ordering. Sorting algorithms are less efficient than the grouping algorithm. The computation time is substantially directly proportional to N*log(N). However, both approaches allow profiles to be constructed in time better than or equal to N*log(N), and use constant RAM. The strategy for “freeing” space within RAM is discussed later.

After the data is contiguously re-ordered, profiles can be built. Profile construction can be performed as described in this paragraph. After a new transaction record is read, the profile for the customer to whom that transaction belongs is initialized. The next transaction is read, and as long as the customer is the same as the customer for the previous record, the profile is updated. If a new customer is detected, the data processing system (e.g., computer 12 or 14) can “package up” the profile for the previous customer and “flush” the customer profile, which frees up RAM space. Note that since only one customer at a time is being processed, the maximum memory used by this routine is a constant bounded by the number of items, I.

During “packaging,” the profile for the previous customer is completed (all calculations, if any, are completed), and the revised information can be sent to and stored in a database 20 or file (e.g., storage medium 34) containing the final profiles. The data from calculations may include maximum amount spent during a transaction or over a time period, average amounts spent per item, per category, per group of categories, or the entire store, and standard deviations for any or all those average amounts. These data for an individual customer can be examples of values that can be used for individualized results. Therefore, the method can comprise determining an individualized result for each of the customers (block 332).

After packaging, the data processing system (computer 12 or 14) frees the RAM occupied by the last customer's data and profile before processing information related to the next customer. Thus, a constant amount of memory is used.

At substantially the same time as individual customer profiles are being computed (determined), group-wide results may be determined as shown in block 334. For example, each time an individual's profile of category spending is calculated, counters can be updated which have the total category spending of the population. Also sums of squares in each category can be updated, and later used to recover the standard deviation of purchasing in each category. Doing these operations together decreases the number of passes through the data, and speeds up the method.

3. Transform, normalize, and record the preferences.

The transformation, normalization, and recording described in this section are typically performed for the item-preference model that will be described later. The data assembled as described in this section may not be needed for some of the other models.

Customer profiles (described in section 2) may need to be transformed in order to be meaningful. For instance, a profile of total spending in each category within a grocery store may result in almost everyone having the same highest scoring items (e.g., bread, milk, and eggs). But this does not indicate that every customer “likes” these products. As used herein, “category” is used to refer an item, a group of items, or a group of those groups. Therefore, a category may be used to refer to an item, a traditional category of items, or an entire department of a store.

In order to reveal categories that customers “prefer,” the profiles should be normalized. In one embodiment, item preferences can be determined using z-scores or percentages of total spending.

For example, a customer who spends $10 on laundry detergent, $3 on apples, and $4 on soup would have a profile of 10/17, 3/17, 4/17 or 58%, 18%, 24%. Converting spending amounts to percentages of total spending ensures that profiles are spending-size invariant. However, this transform still does not address the fact that some products are more expensive or bought more often than others. Thus, some products will have ranges that are always larger than others this is a numerical artifact which has nothing to do with that customer liking that product more than others. To address this problem, the resulting vectors are converted into z-scores.

A z-score can be calculated by taking an amount spent by a customer, subtracting an amount spent by an average customer within a group, and dividing the difference by the standard deviation for the group. For example, assume the average spending of a group the customer belongs to, for the same three categories, is 41%, 18%, 41%. The difference is 58%, 18%, 24% 41%, 18%, 41%=+17%, 0%, −1 Assume that the standard deviation for the three items is 100%, 100%, 100%. The z-score preference vector is +0.17, 0.0, −0.17. From this, the customer is spending more than usual in laundry detergent, less than usual on soup, and about average for apples.

An item preference score (regardless of fractional, differential, or z-score and whether vector or single point) for an individual customer is an example of an individualized result. An item preference score for a group of customers is an example of a group-wide result.

4. Build a model to predict potential purchasing amount.

The basic strategy for predicting potential is to map customer behavior to expected revenue. Instead of using a survey to elicit future behavior (e.g., revenue potential), the population is used to provide examples of historic behavior (e.g., actual revenue). Thus, the transaction data can be used as a kind of “implicit survey”, to learn what patterns of behavior result in different levels of spending.

The potential prediction method can use several guiding principals. Firstly the method should run in linear or N*log(N) time. Secondly, the potential score should be used to predict the average spending level that a customer of this type can attain, rather than the maximum predicted level that the customer can attain. The reason is because averages take into account many points of data, whereas maximums may be exaggerated by atypical outliers, unusual circumstances, or data errors, which may decrease the overall reliability of the potential score. Finally, the model should preferably use behavioral variables to predict revenue.

A reason for avoiding variables that are linearly dependent with the dependent variable could be that they would result in the model arriving at an identity mapping. For example, assume someone tried to predict revenue based on what he or she thought was a behavioral variable (e.g., the number of units a customer has purchased in each category). If most items were sold for a price of approximately $2.00, the model will “learn” that revenue is roughly twice the sum of all items. The model has not “learned” anything about what patterns of behavior by low-spending customers are indicative of a high-spending customer.

For this reason, the variables used for estimating potential should (unless there are reasons to do otherwise) have total revenue removed (for instance via a normalization process), leaving predominantly a set of behaviors that may be used with high-spenders and low-spenders alike. The z-score of percentage normalization method described in section 3 does this, since high-spenders and low-spenders have their profiles divided by total spending, prior to being z-score transformed. In addition, the z-scores prevent more expensive products from pushing their scores higher. All scores will occupy the same mean and standard deviation. With these general principals in mind, the methods for predicting customer potential will now be introduced.

Three specialized predictive model portions for predicting potential are described below. An advantage of the methods is that they can be used to train and execute quickly (all acts can be performed with just a few passes of the data), they are intuitive to understand, and experimental data suggest that they can be used to correctly predict potential.

The models discussed below include an item preference model, a maximum spending model, a geographic model, or any combination of those models.

4.1 Item preference model.

An objective of the item preference model is to predict expected revenue based on the mix of items that the customer “prefers” compared to other customers.

In one embodiment, the model includes a nearest neighbor model where the centroids are fixed to be the average profile from all customers within a specific rank. First, the Nth, N+1th, N+2th, etc., percentiles for revenue are determined. Nearly any number of groups or percentiles could be used.

An algorithm that can be used to determine percentiles in N*log(N) time and constant RAM can comprise disk-merge sorting all customer revenues and then determining the percentiles desired (e.g., first percentile=average of revenues from customers 1 to 1/N*population_size, second percentile=average of revenues from customers (1/N*population_size+1 to 2/N*population_size), etc.) A different algorithm can be used to determine approximate percentiles in a time directly proportional to N was proposed by Don Spiliotis at Datasage, Inc. in 1999. First, a quantization of 1,000,000 (or more) bins can be created between the expected minimum and maximum revenue amount (the granularity can also be any convenient level, for instance each bin might represent a $1 increment). Next, the method can be used to review the data and find the bin into which each customer's revenue falls. A very fine-grained histogram may be generated. Finally, the method can further comprise merging each neighboring bin in one direction (e.g., left to right) until the merged bin contains approximately 1/N^{th}*number_of_customers customers. The average of the histograms comprising that merged bin is the revenue for this percentile.

Assume the percentiles are $0.20, $0.90, $3.05, $10.05, . . . , $160.43. The method can be used to determine into which revenue group each customer falls. An aggregate profile for this revenue group is then updated. After processing the data, for each revenue group, an average profile for customers within that revenue group is obtained.

This technique differs from other nearest neighbor techniques in that the centroids have been forced to occupy the position of the Nth, N+1th, etc, revenue percentiles. The technique can be used to give a balanced spread of profile prototypes across the population, so that there will be examples of high and low-spending customers in proportion to their prevalence in the population.

Another way to understand this, is that there are only have a limited number (e.g., 10) of prototype customers that are “allowed” to be kept in a code-book which will be used to describe the entire population. With such few codes, there is a risk that the 10 customers selected for prototypes might be atypical, just by random chance. The problem can be solved by forcing each centroid to cover exactly 1/Nth=1/10^{th} of the population. This ensures that every type of customer in the population is “covered” with one (and exactly one) code-book entry. Thus, this approach deploys coding resources as efficiently as possible, in trying to cover all customers in the population.

After building this model, there are N group-wide prototypes, and the group-profiles can be used to predict revenue.

For each customer, the item preference vector for the individual is compared to the item preference vectors for each of the groups. The method can be used to determine that the individualized result for the customer most closely matches the group-wide result for one of the groups (block 342). The method can be used to assign a value to the potential purchasing amount for the customer (block 352).

In a specific example, assume that a customer's item preference vector most closely matches the second decile preference vector. Let average second decile spending equal $US100 per week. Using the nearest neighbor model, the customer is assigned a potential purchasing amount of US$100 per week.

The nearest neighbor model is good because it can be built in linear time and relatively constant sized RAM. Therefore, the model is scalable to large amounts of data.

Variants of the nearest neighbor strategy can also be used and include Generalized Regression Neural Nets. A novel aspect is the initial seeding of centroids described earlier, and the utilization of linear time methods.

4.2 Maximum revenue per transaction or time period (e.g., daily, weekly, monthly, etc.).

A skilled artisan may define potential as the maximum amount a customer will spend. However, this measure is susceptible to outliers and bad data that would likely harm the predictive value of the potential measure. In contrast, averages use all data points, and so are less susceptible to outliers and bad data. Medians may be even more robust to bad data, however medians may require more than one pass of the data to calculate, but they can still be used.

The objective of this model is to map a variable based on maximum spending to an expected revenue, using a nearest neighbor method. This technique can work by keeping track of the maximum amount the customer has spent during any single transaction or over a period of time (e.g., daily, weekly, monthly, etc.). A customer may have visited one of the vendor's sites in the past and spent $US180 dollars in a single day. Because of this, the customer has the capacity to spend $US180 in a week. However, the US$180 number is not assigned to the customer's potential purchasing amount because it may be an outlier or reflect bad data. For example, the US$180 may have been spent on a one time reunion or party for family or friends and may not ever reoccur or may be repeated many years later.

Instead of reporting the raw maximum amount the customer spent, a nearest neighbor match can be performed between the customer's maximum spending and the 10 average maximum spending levels for the groups. For example, the third decile may have an average daily maximum spent of US$170 (group-wide result). The method is used to determine that the US$180 for the customer (individualized result, block 332) most closely matches the US$170 of average daily maximum for the third decile (group-wide result, block 334) for one of the groups as illustrated in block 342 of FIG. 3. The average weekly revenue for a third decile customer may be US$90. The customer with the daily maximum spending of US$180 may be assigned a potential of US$90 per week rather than the US$180 maximum of the individual or the US$170 daily maximum for the average third decile customer. Therefore, the method can be used to assign a value for the potential purchasing amount for the customer (block 352).

The modification (use of the average spent instead of maximum spent) allows more conservative estimates for potential because the averages take into account a large number of customers. Average, rather than daily maximum spent, is used because averages are not as strongly affected by outliers or bad data. This keeps with the technique of reporting the average, rather than the maximum spent, as the potential of the customer.

Similar to the item preference model, variants can be used.

One of the guidelines for predicting potential would be to use variables that are not linearly-dependent with revenue. Max 1 day spending meets this criterion because the customer's spending on any one day may be quite different from their average spending per week. In addition, in experimental tests maximum revenue was found to be one of the best models in predicting customer potential.

4.3 Geographic model portion.

Assuming the vendor knows geographic information about a customer, the vendor can use that information to predict the potential with a geographic model. Two techniques for making this prediction are described below.

4.3.1 Distance to store.

Reilly (Reilly, W. J. (1931), The Law of Retail Gravitation, University of Texas, Austin, Tex.) was the first to notice that cities tended to attract people from outlying areas inversely proportional to distance and proportional to the city-size of the attracting center.

An extension of this concept is that customer spending should be inversely proportional to the distance between the customer and a store. This principal may be used to predict the spending of customers, based on their location in outlying districts from the store.

For example, customers who are at a distance of one mile from the store may to spend a particular average amount at the store. If a customer is found to be spending much lower than this average amount, he or she is predicted to be spending below his or her potential.

The geographic model can be computed in several ways. One embodiment uses the same nearest neighbor approach as used in the other models. The nearest neighbor algorithm has the advantage of running in linear time, and constant memory.

For each customer, his or her distance to the store is compared with the Nth, N+1th, N+2th, etc. distance percentiles. For each distance, the average spending of customers in that distance bracket from the store or competitor can be calculated. This average amount is the amount a customer at this distance would be predicted to spend.

Other approaches, including regression, could also be used to compute the distance-potential function. A linear regression of distance onto revenue can be computed in one pass, with constant memory, since there is only one variable (no matrix inversion).

The geographic model can also use the ratio of distance-to-store over distance-to-competitor, or another convenient variable which uses competitor distance information.

4.3.2 Geographic indicators

A geographic indicator can also be used to estimate income, and hence predict potential. In the United States, a zipcode+4 can be a good predictor of average income level. In larger cities, the zipcode by itself may be sufficient. Other regional indicia including telephone numbers (area code and local exchange) could be used instead of a zipcode (or postal codes in other countries). Assuming the store knows the addresses of many of its customers, the store can calculate the average amount spent by customers in each area. An individual customer can be matched to his or her area and assigned the average amount spent by customers in that area. This method can then use this to predict the potential purchasing amount for any new customer.

The geographic models are usable as long as the retailer has collected address or telephone number data for their customers. Once more, this approach should satisfy privacy provisions, as the retailer does not share personal information. Furthermore, using the approaches described herein, models can be computed in linear time and constant RAM.

4.4 A global model.

A value can be assigned for the purchasing potential amount for the individual customer using a combination of any two or more of the models previously described. The value may be determined using the following approximation.

p.p.a. approximately equals a*(i.p.m.)+b*(m.s.m.)+c*(g.m.)

where, p.p.a. can be the potential purchasing amount for the individual customer;

i.p.m. can be a value from one or more of the item preference models;

m.s.m. can be a value from one or more of the maximum spending models;

g.m. can be a value from one or more of the geographic models; and

a, b, and c can be parameters.

The maximum spending model term (second term of the approximation) may have the greatest impact on the potential. The next highest impact may be the item preference model term. The item preference factor (a) may be no greater than approximately 0.5; the maximum spending factor (b) may be at least approximately 0.5; and geographic factor (c) may be no more than approximately 0.2.

A few examples give some insight to the method. The vendor may be an urban grocery store. In this instance, the item preference factor (a) may be no more than approximately 0.3, the maximum spending factor (b) may be at least approximately 0.7, and the geographic factor (c) may be no greater than approximately 0.1. In yet another example, the model could be for a store that is either a hardware store or a department store in a rural area. In this instance, there may be more emphasis based on geographic model. For example, the maximum spending factor (b) may be at least approximately 0.5 and the item preference factor (a) may be no greater than approximately 0.3. However, unlike a grocery store that may sell perishable or frozen items that need to be frozen or refrigerated relatively quickly, an individual customer may travel farther especially as expected savings increase. Therefore, the geographic model factor (c) may be greater than zero but no more than approximately 0.2. In some instances, any of the factors (a, b, or c) can be zero. The geographic factor (c) may be zero more often compared to the other factors. The numbers that are presented are not to be considered constraints but merely illustrative examples of numbers that could be used. The actual numbers may be better based on collection of real data to determine what fits best based on data actually collected.

5. Iterate for each customer.

The process of assigning potential as described above can be repeated for the rest of the customers, if this has not been done, or when new transactional data is entered.

Now that the potential purchasing amounts for individuals have been determined, the store may want to target individual customers spending under their potential for additional service, promotions, coupons or the like. For example, if the customer is spending approximately 20% less than his or her potential, then the store may target a generic coupon for that customer. If the amount that the customer is spending is less than 50%, the store may provide deeper discounts. Note with the examples previously given with the item preference and maximum spending models, the customer is spending about US$20 per week at the store, but either model, or a combination of the two predict that the customer should be spending between approximately US$90 to US$100 per week.

Conversely, customers that are spending above their predicted potential may not be targeted with the same offers or other promotions. If the customer is already above their potential, the retailer might conclude that more offers or promotions may not get the customer to spend more. In this case, the offer or promotion can effectively be a loss to the vendor, since customers will often take advantage of the special price discounts provided by coupons.

The difference between the actual spending and the predicted potential purchasing amount for the specific example can indicate that the customer may be purchasing most of the items, which the vendor sells, from a competitor. The action taken is highly variable and can be tailored both to the vendor and the characteristics of the customer.

Empirical data may suggest that the customers that are spending below their predicted potential are more responsive to offers or other promotional items. When compared to randomly selected customers receiving the same offer, the customers that are spending below their predicted potential can show a significant increase in revenue, profits, and visits to the site(s) of the vendor.

Different size groups can be used for the different model portions. For example, the item preference model may use deciles, the maximum spending model portion may use octiles, and the geographic model may have one group for each zipcode+4. Even within the item preference model, z-score and fractional item preferences may use different groupings.

The methods described herein can be used to handle well over one million rows of transaction data. In one particular example, a grocery store chain with 250 million rows of data from ½ million customers could be processed using the method. The data may be processed on a personal computer having two microprocessors, 2 gigabytes of RAM and 100 gigabytes of hard disk space.

The parsing of data into deciles (groups) can take as little as one pass of the data, and generating the item preference scores (z-score or fractional item preferences) may take no more than two passes of the data. The maximum spending model portion may take no more than two passes of the data and may be performed as part of the two passes used when generating the item preference scores. Assuming a 20 GB Oracle database with 250 million rows of customer-keyed transactional data, one database scan may take approximately ten hours of time. Hence, keeping the time complexity of the method linear is extremely advantageous.

The method may have an advantage over prior art because the method can be implemented by nearly anyone having a moderately sized personal computer (e.g., computer 12). The need for a mini-computer or a mainframe computer is not required because the techniques employed can be designed to use substantially constant amount of RAM space and run in linear or near-linear time. RAM-intensive statistical data processing measures, such as regression (which involves matrix inversion) are not required. Sampling is not required because the utilization of RAM allows all the data to be used in constructing models. The system is scalable because it uses algorithms which have linear or near-linear running (computational) times (a function of N and is directly proportional N or N*log(N)), while using a substantially constant size of RAM space.

Another benefit is that the information used for determining the purchasing potential can be generated using only customer and point of sales data that most stores routinely collect for inventory, accounting, or other purposes. The transactional data can be all internal to the store. By internal, it is meant that the data is collected through the normal events within the store itself. A chain of stores does not need to perform (or have performed) surveys, pay for third party information regarding its customers, or take part in any information sharing with third parties.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a nonexclusive inclusion, such that a process, method, article, or apparatus that comprises a list of elements does not include only those elements but may include other elements not expressly listed or inherent to such process, method, article, or apparatus.

1. A method of predicting a business potential for a first customer comprising:
accessing data regarding the first customer of a vendor; and
assigning a value for the business potential for the first customer, wherein the value is a function of at least a behavior for a group of other individuals in a population and is based at least in part on the data.

2. The method of claim 1, further comprising:
determining an individualized result and a group-wide result, wherein:
the individualized result includes a maximum amount spent by the first customer during a first transaction or over a first time period, wherein the maximum amount spent by the first customer is obtained from the data; and
the group-wide result includes a function of maximum amounts spent by other customers within a group of customers during a second transaction or over second time period; and
comparing the individualized result with the group-wide result.

3. The method of claim 1, further comprising:
determining an individualized result and a group-wide result, wherein:
the individualized result includes an individual preference score based on items purchased by the first customer, wherein the individual preference score is obtained from the data; and
the group-wide result includes a group-wide preference score based on items purchased by other customers within a group of customers; and
comparing the individualized result with the group-wide result.

4. The method of claim 1, further comprising using the data to determine an approximate distance between the first customer and a location of a vendor, wherein the distance is used in determining the value.

5. The method of claim 1, further comprising using the data to determine a geographic indicator, wherein the geographic indicator is used in determining the value.

6. The method of claim 1, further comprising:
collecting the data, wherein the data includes transactional data internal to the vendor; and
storing the data,
wherein the acts of collecting, storing, accessing, and assigning are performed by the vendor.

7. The method of claim 1, wherein the method takes a computational time that is substantially directly proportional to N or N*log(N), wherein N is a product of a number of customers and a number of items carried by the vendor or a site of the vendor.

8. The method of claim 1, wherein the value is determined by at least two of an item preference model, a maximum spending model, and a geographic model.

9. The method of claim 1, wherein the at least a behavior includes an average spending amount for a group of customers within the population.

10. A data processing system readable medium having code embodied therein, the code including instructions executable by a data processing system, wherein the instructions are configured to cause the data processing system to:
accessing data regarding the first customer of a vendor; and
assigning a value for the business potential for the first customer, wherein the value is a function of at least a behavior for a group of other individuals in a population and is based at least in part on the data.

11. The data processing system readable medium of claim 10, wherein the method further comprises:
determining an individualized result and a group-wide result, wherein:
the individualized result includes a maximum amount spent by the first customer during a first transaction or a first time period, wherein the maximum amount spend by the first customer is obtained from the data; and
the group-wide result includes a function of maximum amounts spent by other customers within a group of customers during a second transaction or second time period; and
comparing the individualized result with the group-wide result.

12. The data processing system readable medium of claim 10, wherein the method further comprises:
determining an individualized result and a group-wide result, wherein:
the individualized result includes an individual preference score based on items purchased by the first customer, wherein the individual preference score is obtained from the data; and
the group-wide result includes group-wide preference score based on items purchased by other customers within a group of customers; and
comparing the individualized result with the group-wide result.

13. The data processing system readable medium of claim 10, wherein the method further comprises using the data to determine an approximate distance between the first customer and a location of a vendor, wherein the distance is used in determining the value.

14. The data processing system readable medium of claim 10, wherein the method further comprises using the data to determine a geographic indicator, wherein the geographic indicator is used in determining the value.

15. The data processing system readable medium of claim 10, wherein the method further comprises:
collecting the data, wherein the data includes transactional data internal to the vendor; and
storing the data,
wherein the acts of collecting, storing, accessing, and assigning are performed by the vendor.

16. The data processing system readable medium of claim 10, wherein the method takes a computational time that is substantially directly proportional to N or N*log(N), wherein N is a product of a number of customers and a number of items carried by the vendor or a site of the vendor.

17. The data processing system readable medium of claim 10, wherein the value is determined by at least two of an item preference model, a maximum spending model, and a geographic model.

18. The data processing system readable medium of claim 10, wherein the at least a behavior includes an average spending amount for a group of customers within the population.
